(19) United States
(12) Patent Application Publication
(10) Pub. No.: US 2014/0260800 A1
(43) Pub. Date: Sep. 18, 2014

(54) METHOD FOR PRODUCING MAGNETIC POWDER FOR FORMING SINTERED BODY THAT IS PRECURSOR OF RARE-EARTH MAGNET

(71) Applicant: TOYOTA JIDOSHA KABUSHIKI KAISHA, Aichi (JP)

(72) Inventors: Noritsugu Sakuma, Susono-shi (JP); Hidefumi Kishimoto, Susono-shi (JP); Noritaka Miyamoto, Toyota-shi (JP); Akira Kato, Mishima-shi (JP); Akira Manabe, Toyota-shi (JP); Daisuke Ichigozaki, Toyota-shi (JP); Tetsuya Shoji, Toyota-shi (JP); Shoichi Harakawa, Susono-shi (JP)

(73) Assignee: TOYOTA JIDOSHA KABUSHIKI KAISHA, Toyota-shi, Aichi-ken (JP)

(21) Appl. No.: 14/350,447

(22) PCT Filed: Oct. 9, 2012
(86) PCT No.: PCT/JP2012/076065

§ 371 Date: Apr. 8, 2014

(30) Foreign Application Priority Data
Oct. 11, 2011 (JP) 2011-224115

(51) Int. Cl. H01F 1/20; B22F 9/04

(52) U.S. Cl. CPC H01F 1/20; B22F 9/04
USPC 75/347

(57) ABSTRACT

A method for producing magnetic powder for forming a sintered body that is a precursor of a rare-earth magnet. Provided is a method for producing magnetic powder for forming a sintered body that is a precursor of a rare-earth magnet, which can produce magnetic powder with a structure containing optimal nanosized crystal grains by accurately and efficiently sorting out magnetic powder containing no coarse grains in the structure thereof. A method for producing magnetic powder p for forming a sintered body S that is a precursor of a rare-earth magnet, the sintered body S including an Nd—Fe—B-based main phase with a nanocrystalline structure, and a grain boundary phase around the main phase, and the rare-earth magnet being adapted to be formed by applying hot deformation processing to the sintered body S for imparting anisotropy thereto and diffusing an alloy for improving coercivity therein, the method including discharging a metal melt onto a chill roll R to produce a quenched ribbon B, and grinding the quenched ribbon B into grains in the size range of 50 to 1000 μm to produce magnetic powder in the mass range of 0.0003 to 03 mg; conducting a test to see whether or not the magnetic powder in the mass range adsorbs onto a magnet with a surface magnetic flux density of 2 mT or less, and sorting out magnetic powder p that has not adsorbed onto the magnet, as the magnetic powder for forming the sintered body S.

### TECHNICAL FIELD

The present invention relates to a method for producing magnetic powder for forming a sintered body that is a precursor or a rare-earth magnet.

### BACKGROUND ART

Rare-earth magnets that use rare-earth elements, such as lanthanoid, are also called permanent magnets. Such magnets are used not only for hard disks or motors of MRI but also for driving motors of hybrid vehicles, electric vehicles, and the like.

As examples of magnetic performance indices of such rare-earth magnet, remanent magnetization (i.e., residual magnetic flux density) and coercivity can be given. However, with a reduction in the motor size and an increase in the amount of heat generation accompanied by an increase in the current density, there has been an increasing demand for higher heat resistance of the rare-earth magnet being used. Thus, how to retain the coercivity of a magnet under high-temperature use environments is an important research object to be achieved in the technical field. For example, for a Nd—Fe—B-based magnet, which is one of the rare-earth magnets that are frequently used for vehicle driving motors, attempts have been made to increase the coercivity by, for example, reducing the crystal grain size, using an alloy with a high Nd content, or adding a heavy rare-earth element with high coercivity performance, such as Dy or Tb.

Examples of rare-earth magnets include typical sintered magnets whose crystal grains (i.e., a main phase) that form the structure have a scale of about 3 to 5 μm, and nanocrystalline magnets whose crystal grain size has been reduced down to a nano-scale of about 50 to 300 nm. Among them, nanocrystalline magnets for which the amount of addition of an expensive heavy rare-earth element can be reduced (i.e., reduced to zero) while the crystal grain size can also be reduced as described above are currently attracting attention.

The resource cost of Dy, which is frequently used among heavy rare-earth elements, has been rapidly increasing since the Japanese fiscal year 2011 as the prospecting areas of Dy are mostly distributed in China and the amount of production as well as the amount of exports of rare metals, such as Dy, by China is now regulated. Therefore, development of a magnet with a less Dy content, which has a reduced Dy content but has ensured coercive performance, and a Dy-free magnet, which contains no Dy but has ensured coercive performance, is one of the important development tasks to be achieved, and this has been one of the factors that are increasing the degree of attention of nanocrystalline magnets.

A method for producing a nanocrystalline magnet is briefly described below. For example, a melt of a Nd—Fe—B-based metal is discharged onto a chill roll to rapidly solidify the melt, and the resulting quenched ribbon (i.e., quenched thin strip) is ground into magnetic powder, and then the magnetic powder is sintered while pressure is applied thereto, whereby a sintered body is produced. In order to impart magnetic anisotropy to such a sintered body, hot deformation processing (which can also be called hot high-strength processing or be simply called high-strength processing if the degree of processing (i.e., compressibility) of the hot deformation processing is high, for example, when the compressibility is greater than or equal to about 10%, and the sintered body can also be called a precursor of the high-strength processing) is applied to produce a molded body. As described above, in order to produce a rare-earth magnet, a sintered body is produced first as a precursor, and then, a molded body is produced. Such a method for producing a molded body by applying hot deformation processing to a sintered body is disclosed in Patent Literature 1.

A heavy rare-earth element with high coercivity performance, an alloy thereof, or the like is imparted to the molded body obtained through the hot deformation processing, whereby a rare-earth magnet made of a nanocrystalline magnet is produced.

It has been found that when a sintered body contains crystal grains without coarse grains, if the sintered body is subjected to hot deformation processing, the crystal grains (typically, a Nd₂Fe₁₄B phase) will turn (or rotate) along with slip deformation due to the hot deformation processing, and the easy axis of magnetization (i.e., the c-axis) will be oriented in the processing direction (i.e., the press direction), whereby a molded body with a high degree of orientation can be obtained, and also the remanent magnetization can be increased. In this specification, among the nanocrystalline grains, a crystal grain with the maximum diameter of 300 nm or greater will be defined as a “coarse grain.” It has also been found that when such coarse grain is present, or when the percentage of such coarse grains is high, rotation of the crystal grains will be suppressed, and thus, the aforementioned degree of orientation will be likely to decrease.

The inventors have arrived at, in the production of magnetic powder that is a raw material of a sintered body, a method for producing magnetic powder for forming a sintered body with a structure containing optimal nanosized crystal grains, by accurately and efficiently sorting out magnetic powder containing no coarse grains in the structure thereof.

### CITATION LIST

### Patent Literature

Patent Literature 1: JP 2011-100881 A

### SUMMARY OF INVENTION

### Technical Problem

The present invention has been made in view of the foregoing problems. The present invention relates to a method for producing magnetic powder for forming a sintered body that is a precursor of a rare-earth magnet, and an object of the present invention is to provide a method for producing magnetic powder for forming a sintered body that is a precursor of a rare-earth magnet, with which magnetic powder with a structure containing optimal nanosized crystal grains can be produced by accurately and efficiently sorting out magnetic powder containing no coarse grains in the structure thereof.

### Solution to Problem

In order to achieve the above object, a method for producing magnetic powder for forming a sintered body that is a precursor of a rare-earth magnet in accordance with the present invention is a method for producing magnetic powder for forming a sintered body that is a precursor of a rare-earth magnet, the sintered body including an Nd—Fe—B-based main phase with a nanocrystalline structure, and a grain boundary phase around the main phase, and the rare-earth magnet being adapted to be formed by applying hot deformation processing to the sintered body for imparting anisotropy thereto and further diffusing an alloy for improving coercivity therein, the method including: discharging a metal melt with the composition onto a chill roll to produce a quenched ribbon, and grinding the quenched ribbon into grains in a size range of 50 to 1000 μm to produce magnetic powder in a mass range of 0.0003 to 0.3 mg; conducting a test to see whether or not the magnetic powder in the mass range adsorbs onto a magnet with a surface magnetic flux density of 2 mT or less, and sorting out magnetic powder that has not adsorbed onto the magnet, as the magnetic powder for forming the sintered body.

The method for producing magnetic powder of the present invention is a method for producing magnetic powder in which the grain size range for grinding the obtained quenched ribbon into magnetic powder is adjusted, and a magnetic separation method is applied to the magnetic powder in such a grain size range and in a predetermined mass range so as to sort out magnetic powder that contains no coarse grains or contains an extremely small amount of coarse grains, so that the magnetic powder is used as the magnetic powder for forming the sintered body.

The inventors have identified that, by conducting a test to see whether or not magnetic powder, which has been obtained through a grinding process performed in the grain size range of 50 to 1000 μm, in the mass range of 0.0003 to 0.3 mg, adsorbs onto a magnet with low magnetic properties, i.e., with a surface magnetic flux density of 2 mT or less, magnetic powder containing no coarse grains can be accurately sorted out.

“2 mT or less” herein means that since magnetic powder to be tested is in the mass range of 0.0003 to 0.3 mg, a magnet with a surface magnetic flux density of 2 mT, 1.5 mT, or 1 ml is used in accordance with the mass in such a mass range. It is needless to mention that in order to sort out magnetic powder containing no coarse grains, it is necessary to change the surface magnetic flux density of a magnet in accordance with the mass of the magnetic powder to be tested. However, the inventors have identified that when the mass of the magnetic powder is either too much or too small, magnetic powder containing no coarse grains cannot be accurately sorted out. The inventors have found that conducing a test to see whether or not magnetic powder in the mass range of 0.0003 to 0.3 mg adsorbs onto a magnet with low magnetic properties of 2 mT or less is optimal for sorting out the magnetic powder, by conducting numerous experiments (by variously changing the mass range of the magnetic powder and the magnetic flux density of the magnet with low magnetic properties to see what mass range and what magnetic flux density of a magnet can accurately sort out magnetic powder containing no coarse grains).

After the magnetic powder in the mass range of 0.0003 to 0.3 mg is adsorbed onto a magnet with low magnetic properties of 2 mT or less, the magnetic powder adsorbed onto the magnet with low magnetic properties is found to have low coercivity as it contains coarse grains, while the magnetic powder not adsorbed onto the magnet with low magnetic properties is found to have high coercivity as it contains no coarse grains or contains an extremely small amount of coarse grains. Thus, the magnetic powder that has not been magnetically adsorbed is collected and used for the production of a sintered body. In this case, if the grain size of the magnetic powder is over 1000 μm, it would be difficult to apply the magnetic separation method, while if the grain size is less than 50 μm, the magnetic properties would significantly decrease due to distortion that is introduced during grinding. Thus, the grain size range of the magnetic powder is set to 50 to 1000 μm.

A magnet that is used when a magnetic attraction method is applied may be either an electromagnet that is obtained by winding a coil around a soft magnetic member and making current to flow through the coil to generate a magnetic field, or a permanent magnet with low magnetic properties. Further, when a magnet with a shape/configuration that can generate a uniform magnetic field in a wide range as soon as possible is applied, it becomes possible to increase the efficiency of sorting out magnetic powder. Examples of such a shape/configuration include a cylinder, a plurality bars arranged at intervals, and a plate.

In addition, provided that a region of the magnetic powder corresponding to a region of the quenched ribbon, which is a precursor of the magnetic powder, on the chill roll side is a roll-surface-side region of the magnetic powder, and a region corresponding to a region of the quenched ribbon on the opposite side of the chill roll is a free-surface-side region, and further, the average grain size of the crystal grains in the free-surface-side region of the magnetic powder is D_{free}, and the average grain size of the crystal grains in the roll-surface-side region of the magnetic powder is Dᵣₒₗₗ, D_{free} is preferably in the range of 20 to 200 nm, and D_{free}/Dᵣₒₗₗ is preferably in the range of 1.1 to 10.

The inventors have verified that when the magnetic properties of a molded body, which is obtained by further applying hot deformation processing to a sintered body formed of magnetic powder that does not adsorb onto a magnet with a surface magnetic flux density of 2 mT or less, is compared with the magnetic properties of a molded body obtained from a sintered body formed of magnetic powder that adsorbs onto the magnet, the former molded body has a degree of orientation of 93 to 94% and a remanent magnetization of 1.42 to 1.44 T, while the latter molded body has a degree of orientation of 87 to 90% and a remanent magnetization of 1.27 to 1.35 T, and thus, there is a big discrepancy in the remanent magnetization due to the difference in the degree of orientation, and there is also a discrepancy in the coercivity.

According to the above verification, when the grain size distribution of a sintered boy before hot deformation processing is applied thereto is in the range of 50 to 1000 μm, and further, when D_{free} is in the range of 20 to 200 μm and D_{free}/Dᵣₒₗₗ is in the range of 1.1 to 10, it is possible to increase the degree of orientation (i.e., remanent magnetization resulting from the degree of orientation) as well as the coercivity of the molded body obtained after the hot deformation processing. Herein, when a single-sided cooling quench device (i.e., a chill roll) is used for a quenched ribbon that is a precursor of the magnetic powder, the free-surface side that is not in contact with the chill roll has a lower solidification rate, and thus the grain growth on the free-surface side is promoted more than the grain growth on the roll-surface side that is in contact with the chill roll, and also, a Nd-rich phase is deposited due to solidification of the residual liquid phase.

Such a Nd-rich grain boundary phase is necessary to allow sintering at a low temperature. Provided that the average grain size of the crystal grains in the free-surface-side region of the magnetic powder is D_{free}, and the average grain size of the crystal grains in the roll-surface-side region of the magnetic powder is Dᵣₒₗₗ, if D_{free}/Dᵣₒₗₗ is adjusted to be in the range of 1.1 to 10, and further, if D_{free} is adjusted to be in the range of 20 to 200 nm, the grain size can be reduced, and a sintered body containing homogenized magnetic powder can be obtained, which is considered to be the reason that the degree of orientation for when a molded body is formed through hot deformation processing is increased to 93 to 94%, and the remanent magnetization is increased to 1.42 to 1.44 T.

In particular, when D_{free}/Dᵣₒₗₗ is adjusted to the range of 1.1 to 10, a Nd-rich phase that has a low melting point and is close to a liquid-phase state is deposited on the free-surface-side region of the magnetic powder as described above. Thus, low-temperature sintering becomes possible, and this can suppress coarsening of the crystal grains.

The sintered body of the present invention is produced using the aforementioned magnetic powder, and when hot deformation processing (or high-strength processing) is applied to the sintered body, an anisotropic molded body is produced.

A heavy rare-earth element (e.g., Dy, Tb, or Ho) with high coercivity performance, an alloy thereof (e.g., Dy—Cu or Dy—Al), or the like is diffused in the grain boundaries of the produced molded body using various methods, whereby a rare-earth magnet made of a nanocrystalline magnet that is excellent in both magnetization and coercivity is obtained.

### Advantageous Effects of Invention

As can be understood from the foregoing description, according to a method for producing magnetic powder for forming a sintered body that is a precursor of a rare-earth magnet of the present invention, the grain size range for grinding the obtained quenched ribbon into magnetic powder is adjusted, and a magnetic separation method using a magnet with low magnetic properties is applied to the magnetic powder in such a grain size range and in a predetermined mass range so as to sort out magnetic powder that contains no coarse grains or contains an extremely small amount of coarse grains, and then a sintered body made of the sorted-out magnetic powder is subjected to hot deformation processing, whereby a molded body with an extremely high degree of orientation as well as high remanent magnetization and high coercivity, and a rare-earth magnet formed of such a molded body can be produced.

### BRIEF DESCRIPTION OF DRAWINGS

FIG. 1(a) is a diagram illustrating a method for producing magnetic powder, FIG. 1(b) is a diagram illustrating a method for producing a sintered body, and FIG. 1(c) is a diagram illustrating a method for producing a molded body.

FIG. 2(a) is a diagram illustrating a method for producing magnetic powder following FIG. 1a, and is a diagram illustrating that magnetic powder is sorted out using a magnetic separation method, FIG. 2(b) is a view of the structure of magnetic powder that is not magnetically adsorbed, and FIG. 2(c) is a view of the structure of magnetic powder that is magnetically adsorbed.

FIGS. 3(a), (b), (c), and (d) are schematic diagrams each illustrating an embodiment of a magnet with low magnetic properties applied to a magnetic separation method.

FIG. 4(a) is a low-magnification SEM image view of a sintered body that is a precursor of a molded body of Example 1 in a magnetic property evaluation test, FIG. 4(b) is a high-magnification TEM image view related to a roll-surface-side region of magnetic powder that forms the sintered body in FIG. 4(a), and FIG. 4(c) is a high-magnification SEM image view related to a free-surface-side region of magnetic powder that forms the sintered body in FIG. 4(a).

FIG. 5(a) is a low-magnification SEM image view of a sintered body that is a precursor of a molded body of Example 2 in a magnetic property evaluation test, and FIGS. 5(b) and 5(c) are low-magnification SEM image views of sintered bodies that are precursors of molded bodies of Comparative Examples 1 and 2, respectively, in a magnetic property evaluation test.

FIG. 6(a) is a TEM image view of a molded body of Example 1, and FIG. 6(b) is a TEM image view of a molded body of Comparative Example 1.

FIG. 7 is a chart illustrating the results of magnetic property evaluation tests of magnetic powder that has been sorted using a magnetic separation method.

FIG. 8 is a chart illustrating the results of the degree of orientation among the results of magnetic property evaluation tests of molded bodies that are precursors of rare-earth magnets.

FIG. 9 is a chart illustrating the results of remanent magnetization among the results of magnetic property evaluation tests of molded bodies that are precursors of rare-earth magnets.

FIG. 10 is a chart illustrating the results of coercivity among the results of magnetic property evaluation tests of molded bodies that are precursors of rare-earth magnets.

### DESCRIPTION OF EMBODIMENTS

Hereinafter, an embodiment of a method for producing magnetic powder for forming a sintered body that is a precursor of a rare-earth magnet of the present invention will be described with reference to the drawings.

### (Method for Producing Magnetic Powder)

FIGS. 1a, 1b, and 1c are flow diagrams that sequentially show the production of a quenched ribbon, the production of a sintered body that uses magnetic powder obtained by grinding the quenched ribbon, and the production of a molded body through application of hot deformation processing to the sintered body. FIG. 1a is a diagram illustrating a method for producing a quenched ribbon. FIG. 2a is a diagram illustrating a method for producing magnetic powder following FIG. 1a, and illustrates that magnetic powder is sorted out using a magnetic separation method, FIG. 2b is a view of the structure of magnetic powder that is not magnetically adsorbed, and FIG. 2c is a view of the structure of magnetic powder that is magnetically adsorbed.

As shown in FIG. 1a, an alloy ingot is melted at high frequency through single-roll melt-spinning in a furnace (not shown) with an Ar gas atmosphere whose pressure has been reduced to 50 kPa or less, for example, and then the molten metal with a composition that will provide a rare-earth magnet is sprayed at a chill roll R made of copper to produce a quenched ribbon B (i.e., a quenched thin strip). Then, the quenched ribbon B is coarsely ground. It should be noted that a region of the quenched ribbon B on the side of the chill roll R (e.g., a region of half the thickness of the quenched ribbon B on the side of the chill roll R) can be called a roll surface, and a region on the opposite side thereof can be called a free surface. The two regions differ in the growth speed of the crystal grains as the distances from the chill roll R differ.

The composition of the molten alloy (i.e., the composition of a NdFeB magnet) is represented by the compositional formula: (Rl)x(Rh)yTzBsMt, where Rl represents one or more light rare-earth elements including Y, Rh represents one or more heavy rare-earth elements including Dy or Tb, T represents a transition metal including at least one of Fe, Ni, or Co, M represents one or more metals selected from Ga, Zn, Si, Al, Nb, Zr, Ni, Cu, Cr, Hf, Mo, P, C, Mg, Hg, Ag, or Au, and 13≦x≦20, 0≦y≦4, z=100−a−b−d−e−f, 4≦s≦20, 0≦t≦3. it is possible to apply the compositions of RlRh phase structures, such as a main phase of (RlRh)2T14B) and a grain boundary phase of (RlRh)T4B4, or the compositions of RlRh phase structures, such as a main phase of (RlRh)2T14B) and a grain boundary phase of (RlRh)2T17.

As a method of coarsely grinding the quenched ribbon B, grinding is performed with a device that can perform grinding with low energy, such as a mortar, a cutter mill, a pot mill, a jaw crusher, or a jet mill. The grain size of magnetic powder obtained through coarse grinding is adjusted to the range of about 50 to 1000 μm, and a magnetic adsorption separation method is applied to eliminate magnetic powder with coarse grains.

To this end, magnetic powder is adsorbed onto a magnet with low magnetic properties. Magnetic powder adsorbed onto a magnet with low magnetic properties has low coercivity as it contains coarse grains, while magnetic powder not adsorbed onto the magnet with low magnetic properties has high coercivity as it does not contain coarse grains. For example, magnetic powder that has not been magnetically adsorbed can be collected and used for the production of a sintered body. At this time, if the grain size is over 1000 μm, it would be difficult to apply the magnetic separation method, while if the grain size is less than 50 μm, the magnetic properties would significantly decrease due to distortion that is introduced during grinding. Thus, the grain size range of the magnetic powder is set to 50 to 1000 μm.

A magnetic separation device 10 such as the one shown in FIG. 2a is used to separate the magnetic powder ground in the aforementioned grain size range into magnetic powder containing no coarse grains and magnetic powder containing coarse grains, and sort out the magnetic powder containing no coarse grains as magnetic powder for forming a sintered body. The “magnetic powder containing no coarse grains” means not only magnetic powder containing no coarse grains at all but also magnetic powder containing an extremely small amount of coarse grains (e.g., about 1 to 10 mass % or less).

The magnetic separation device 10 shown in the drawing has a coil 2 arranged around a soft magnetic metal member 1, and includes a circuit including the coil 2 and a DC power supply 3.

The constituent material, the current value, and the like of the soft magnetic metal member 1 are adjusted to form an electromagnet with the soft magnetic metal member 1 whose surface magnetic flux density is 2 mT or less when current is made to flow through the coil 2. The magnetic flux density can be checked with a gaussmeter 4.

Magnetic powder, which has been ground in the grain size range of 50 to 1000 μm, in the mass range of 0.0003 to 0.3 mg is collected, and a test is conducted to see whether or not such magnetic powder adsorbs onto an electromagnet with a surface magnetic flux density of 2 mT or less.

In the drawing, some of magnetic powder p′ adsorbs onto the electromagnet, while the other magnetic powder p remains at the bottom without adsorption.

Conducting a test to see Whether or not the magnetic powder in the mass range of 0.0003 to 0.3 mg adsorbs onto an electromagnet with a surface magnetic flux density of 2 mT or less can accurately sort out the magnetic powder p containing no coarse grains.

FIG. 2b is a view of the structure of the magnetic powder that has not been magnetically adsorbed, and FIG. 2c is a view of the structure of the magnetic powder that has been magnetically adsorbed.

Magnetic powder in the mass range of 0.0003 to 0.3 mg is adsorbed onto a magnet with low magnetic properties of 2 mT or less. The magnetic powder p′ adsorbed onto a magnet 1 with low magnetic properties is found to have low coercivity as it contains coarse grains, while the magnetic powder p not adsorbed onto the magnet 1 with low magnetic properties is found to have high coercivity as it contains no coarse grains or contains an extremely small amount of coarse grains. Thus, the magnetic powder p that has not been magnetically adsorbed is sorted out and collected, and is used for the production of a sintered body. The process up to this sorting is the method for producing the magnetic powder of the present invention.

The magnetic powder p shown in FIG. 2b contains no coarse grains with a grain size of 300 nm or greater in the structure thereof, has a flat planar shape (which includes a rectangular shape, a shape that is close thereto, and the like in a planar view), and contains isotropic crystal grains g.

In contrast, the magnetic powder p′ shown in FIG. 2c has a crystalline structure including a number of coarse grains g′ with a grain size of 300 nm or greater in the structure thereof.

Herein, embodiments of magnets with low magnetic properties that are used for the magnetic separation method will be described with reference to FIG. 3.

Generating a uniform magnetic field in a wide range as soon as possible can increase the efficiency of sorting out magnetic powder. As an embodiment of such a shape/configuration, it is preferable to apply a cylindrical soft magnetic metal member 1A (i.e., a surface onto which magnetic powder adsorbs is indicated by Kₐᵣₑₐ) such as the one shown in FIG. 3a, a three-dimensional arrangement of a plurality of needle-shaped soft magnetic metal members 1B such as the one shown in FIG. 3b, or a three-dimensional arrangement of a plurality of bar-shaped soft magnetic metal members 1C such as the one shown in FIG. 3c, or further, a plate-like soft magnetic metal member 1D such as the one shown in FIG. 3d.

Provided that, regarding the sorted-out magnetic powder p, a region corresponding to a region of the quenched ribbon B, which is a precursor of the magnetic powder p, on the chill roll side is a roll-surface-side region of the magnetic powder, and a region corresponding to a region of the quenched ribbon B on the opposite side of the chill roll is a free-surface-side region of the magnetic powder, and further, the average grain size of the crystal grains in the free-surface-side region of the magnetic powder is D_{free}, and the average grain size of the crystal grains in the roll-surface-side region of the magnetic powder is Dᵣₒₗₗ, D_{free} is desirably in the range of 20 to 200 nm, and D_{free}/Dᵣₒₗₗ is desirably in the range of 1.1 to 10. It has been identified that when a sintered body is produced using magnetic powder with crystal grains in such a numerical range, and then an anisotropic molded body is produced by applying hot deformation processing to the sintered body, it is possible to obtain a molded body with a high degree of orientation of crystal grains, high remanent magnetization associated therewith, and further, high coercivity.

### (Sintered Body and Production Method Therefor)

FIG. 1b is a diagram illustrating a method fur producing a sintered body. A cavity, which is defined by a carbide die D and a carbide punch P that slides within a hollow space therein, is filled with the produced magnetic powder p as shown in FIG. 1b, and then, pressure is applied thereto with the carbide punch P, and electrical heating is performed with current made to flow in the pressure application direction (i.e., the X-direction), whereby a sintered body S is produced that contains a Nd—Fe—B-based main phase with a nanocrystalline structure (crystal grains in the grain size range of 20 to 200 nm) and a grain boundary phase around the main phase, such as an Nd—X alloy (Where X is a metallic element).

The sintered body is preferably produced under an inert gas atmosphere by setting the heating temperature of electrical heating to the range of 550 to 700° C., which is a low temperature range in which coarsening of the crystal grains does not occur, setting the pressure to 40 to 500 MPa, which is a pressure range in which coarsening can be suppressed, and setting the retention time to less than or equal to 60 minutes.

### (Molded Body and Production Method Therefor)

FIG. 1c is a diagram illustrating a method for producing a molded body. The carbide punch P is made to abut the end faces of the produced sintered body S in the longitudinal direction thereof (in FIG. 1b, the horizontal direction is the longitudinal direction), and hot deformation processing (high-strength processing) is applied thereto while pressure is applied with the carbide punch P (in the X-direction), whereby a molded body C with a crystalline structure containing nanocrystalline grains with magnetic anisotropy is produced.

The hot deformation processing is preferably performed at about 600 to 800° C., which is a low temperature range in which plastic deformation can occur and coarsening of the crystal grains is difficult to occur, and further at a strain rate of about 0.01 to 30/s in a short time, with which coarsening can be suppressed, and desirably, under an inert gas atmosphere to prevent oxidation of the resulting molded body.

The molded body C shown in the drawing is an anisotropic molded body in which crystal grains can easily rotate during hot deformation processing (high-strength processing) and the crystal grains are thus aligned with a high degree of orientation since the structure of the sintered body S that is a precursor of the molded body C contains no coarse grains or contains an extremely small amount of coarse grains, and farther contains crystal grains in the grain size range of 20 to 200 nm with a flat planar shape.

“Magnetic property evaluation tests of magnetic powder sorted using magnetic separation method and results thereof, magnetic property evaluation tests of molded bodies that are precursors of rare-earth magnets and results thereof”

The inventors produced molded bodies of Examples 1 and 2 and molded bodies of Comparative Examples 1 and 2 with the following methods, and conducted experiments of measuring the degree of orientation, remanent magnetization, and coercivity that are the magnetic properties of the molded bodies. The production methods of Examples 1 and 2 and Comparative Examples 1 and 2 are shown below. It should be noted that FIG. 7 is a graph showing the relationship between the degree of orientation (i.e., remanent magnetization (Mr)/saturation magnetization (Ms)) and coercivity determined for the magnetic powder used in the process of forming the molded bodies of Example 1 and Comparative Example 1. Among the results of the magnetic property evaluation tests of the molded bodies of Examples 1 and 2 and the molded bodies of Comparative Examples 1 and 2, FIG. 8 shows the results related to the degree of orientation, FIG. 9 shows the results related to remanent magnetization, and FIG. 10 shows the results related to coercivity. Table 1 shows the results altogether. Further, FIG. 4a shows a low-magnification SEM image view of a sintered body that is a precursor of the molded body of Example 1, FIG. 4b shows a high-magnification TEM image view related to the roll-surface-side region of the magnetic powder that forms the sintered body of FIG. 4a, and FIG. 4c shows a high-magnification SEM image view related to the free-surface-side region of the magnetic powder that forms the sintered body of FIG. 4a, FIG. 5a shows a low-magnification SEM image view of a sintered body that is a precursor of the molded body of Example 2 in the magnetic property evaluation test, FIGS. 5b and 5c show low-magnification SEM image views of sintered bodies that are precursors of the molded bodies of Comparative Examples 1 and 2, respectively, in the magnetic property evaluation test. FIG. 6a shows a TEM image view of the molded body in Example 1, and FIG. 6b shows a TEM image view of the molded body of Comparative Example 1.

### EXAMPLE 1

A quenched ribbon with a composition of Nd29.9Pr0.4Fe64.2Co4.0B0.9Ga0.6 (mass %) containing no coarse grains was produced through single-sided cooling, and the quenched ribbon was ground into magnetic powder. Then, the magnetic powder was held at 600° C. for 10 minutes with a pressured of 400 MPa applied thereto, whereby a sintered body was produced. After the structure of the sintered body was observed with SEM and TEM, hot deformation processing was applied thereto at a temperature of 750° C. and at a strain rate of 7/s to produce the molded body of Example 1. Then, the structure of the molded body was observed with TEM.

### EXAMPLE 2

A quenched ribbon with a composition of Nd29.9Pr0.4Fe64.2Co4.0B0.9Ga0.6 (mass %) containing no coarse grains was produced through single-sided cooling, and the quenched ribbon was ground into magnetic powder. Then, the magnetic powder was held at 650° C. for 10 minutes with a pressure of 100 MPa applied thereto, whereby a sintered body was produced. After the structure of the sintered body was observed with SEM, hot deformation processing was applied thereto at a temperature of 750° C. and at a strain rate of Its to produce the molded body of Example 2.

### COMPARATIVE EXAMPLE 1

A quenched ribbon with a composition of Nd29.9Pr0.4Fe64.2Co4.0B0.9Ga0.6 (mass %) containing coarse grains was produced through single-sided cooling, and the quenched ribbon was ground into magnetic powder. Then, the magnetic powder was held at 600° C. for 10 minutes with a pressure of 400 MPa applied thereto, whereby a sintered body was produced. After the structure of the sintered body was observed with SEM, hot deformation processing was applied thereto at a temperature of 750° C. and at a strain rate of 7/s to produce the molded body of Comparative Example 1. Then, the structure of the molded body was observed with TEM.

### COMPARATIVE EXAMPLE 2

A quenched ribbon with a composition of Nd29.9Pr0.4Fe64.2Co4.0B0.9Ga0.6 (mass %) containing coarse grains was produced through single-sided cooling, and the quenched ribbon was ground into magnetic powder. Then, the magnetic powder was held at 650° C. for 1010 minutes with a pressure of 100 MPa applied thereto. After the structure of the sintered body was observed with SEM, hot deformation processing was applied thereto at a temperature of 750° C. and at a strain rate of 7/s to produce the molded body of Comparative Example 2.

FIGS. 4b and 4c can confirm that the grain growth of the magnetic powder in accordance with Example 1 is promoted more in the free-surface-side region than in the roll-surface-side region, and the confirmed D_{free}/Dᵣₒₗₗ is 1.5 (greater than or equal to 1.1).

FIGS. 6a and 6b can confirm that the planar shapes of the crystal grains that form the molded body of Example 1 are flat (e.g., quadrangles or rhombuses), and the long sides thereof are less than or equal to 200 nm each (and the short sides thereof are naturally less than or equal to 200 nm). Meanwhile, it can be confirmed that the molded body of Comparative Example 1 contains a number of coarse grains that are greater than or equal to 300 nm in the structure thereof.

FIG. 7 shows that, when the magnetic properties of both magnetic powder not adsorbed onto a magnet with low magnetic properties and magnetic powder adsorbed onto the magnet are compared, a gradient of a graph, which crosses the ordinate axis of the coercivity of 0 (kOe), of the magnetic powder adsorbed onto the magnet falls more abruptly (i.e., has a steeper gradient) that that of the magnetic powder not adsorbed onto the magnet. This shows that the remanent magnetization has decreased. It should be noted that multiplying the unit kOe on the abscissa axis by 79.6 can convert the unit into kA/m of the SI unit.

TABLE 1

| | | | Degree of | Remanent | Coercivity |
|---|---|---|---|---|---|
| | D_{free} (nm) | D_{free}/Dᵣₒₗₗ | Orientation (%) | Magnetization (T) | (kOe) |
| Example 1 | 59.1 | 1.48 | 94 | 1.44 | 15.8 |
| Example 2 | 120 | 4.1 | 93 | 1.42 | 15.5 |
| Comparative | 571 | 13.9 | 90.5 | 1.35 | 14.5 |
| Exmaple 1 | | | | | |
| Comparative | 760 | 19 | 87 | 1.27 | 14.1 |
| Exmaple 2 | | | | | |

Table 1 and FIGS. 8 to 10 can confirm that in comparison with the degrees of orientation of Comparative Examples 1 and 2, the degrees of orientation of Examples 1 and 2 are 94% and 93%, respectively, which are far greater than 90% and consequently, the remanent magnetization is significantly higher by about 0.15 T. Further, the coercivity is also higher by about 1 kOe. Thus, the maximum energy product BHmax significantly improves.

The above results are considered to be due to the facts that each of the sintered bodies that are the precursors of Comparative Examples 1 and 2 has a structure that contains a number of coarse grains with a size of 300 nm or greater, and thus, such coarse grains are not aligned at all, which results in a lower degree of orientation of the entire structure, and thus results in significantly decreased remanent magnetization, while each of the sintered bodies that are the precursors of Examples 1 and 2 contains no coarse grains, and contains crystal grains with a size of 200 nm or less and flat planar shapes, whereby each crystal grain can easily rotate during high-strength processing, and thus a molded body with a high degree of orientation can be easily obtained.

Although the embodiments of the present invention have been described in detail above with reference to the drawings, specific structures are not limited thereto. The present invention includes design changes and the like that may occur within the spirit and scope of the present invention.

### REFERENCE SIGNS LIST

1,1A,1B,1C,1D Soft magnetic metal member (Magnet with low magnetic properties
2 Coil
3 DC power supply
4 Gaussmeter
10 Magnetic separation device
R Chill roll
B Quenched ribbon (Quenched thin strip)
D Carbide die
P Carbide punch
S Sintered body
C Molded body
p Magnetic powder containing no coarse grains
p′ Magnetic powder containing coarse grains
g Crystal grains
g′ Coarse grains

1. A method for producing magnetic powder for forming a sintered body that is a precursor of a rare-earth magnet, the sintered body including an Nd—Fe—B-based main phase with a nanocrystalline structure, and a grain boundary phase around the main phase, and the rare-earth magnet being adapted to be formed by applying hot deformation processing to the sintered body for imparting anisotropy thereto and further diffusing an alloy for improving coercivity therein, the method comprising:
discharging a metal melt with the composition onto a chill roll to produce a quenched ribbon, and grinding the quenched ribbon into grains in a size range of 50 to 1000 μm to produce magnetic powder in a mass range of 0.0003 to 0.3 mg; and
conducting a test to see whether or not the magnetic powder in the mass range adsorbs onto a magnet with a surface magnetic flux density of 2 mT or less, and sorting out magnetic powder that has not adsorbed onto the magnet, as the magnetic powder for forming the sintered body.

2. The method for producing magnetic powder for forming a sintered body that is a precursor of a rare earth magnet according to claim 1, wherein provided that a region of the magnetic powder corresponding to a region of the quenched ribbon, which is a precursor of the magnetic powder, on the chill roll side is a roll-surface-side region of the magnetic powder, and a region corresponding to a region of the quenched ribbon on the opposite side of the chill roll is a free-surface-side region, and further, an average grain size of the crystal grains in the free-surface-side region of the magnetic powder is D_{free}, and an average grain size of the crystal grains in the roll-surface-side region of the magnetic powder is Dᵣₒₗₗ, D_{free} is in a range of 20 to 200 nm, and D_{free}/Dᵣₒₗₗ is in a range of 1.1 to 10.
